(19) United States
(12) Patent Application Publication
(10) Pub. No.: US 2015/0041046 A1
(43) Pub. Date: Feb. 12, 2015

(54) METHOD FOR DETERMINING SUBSTRATE, AND MANUFACTURING METHOD FOR FLEXIBLE DISPLAY USING THE SAME

(71) Applicant: SAMSUNG DISPLAY CO., LTD., Yongin-City (KR)

(72) Inventors: Ki Taek Kim, Cheonan-si (KR); Jung Hwa You, Anyang-si (KR)

(73) Assignee: SAMSUNG DISPLAY CO., LTD., Yongin-City (KR)

(21) Appl. No.: 14/097,965

(22) Filed: Dec. 5, 2013

(30) Foreign Application Priority Data
Aug. 8, 2013 (KR) 10-2013-0094247

(51) Int. Cl. G01N 21/27; B32B 37/14; B32B 43/00; B32B 41/00

(52) U.S. Cl. CPC G01N 21/27; B32B 41/00; B32B 37/14; B32B 43/006; B32B 2307/416
USPC 156/64; 356/407

(57) ABSTRACT

An apparatus for determining a substrate is provided, including a light emitting unit, a light receiving unit, a memory unit, and a control unit. The light emit light is configured to emit light onto one surface of the substrate. The light receiving unit is configured to receive light reflected from the one surface of the substrate, and to detect optical information. The memory unit is configured to store the optical information of the received light and a reference value. The control unit is configured to determine whether the one surface of the substrate is a first surface or a second surface of the substrate by comparing the optical information and the reference value.

### CROSS-REFERENCE TO RELATED APPLICATION

This application claims priority under 35 U.S.C. 119 to Korean Patent Application No. 10-2013-0094247, filed on Aug. 8, 2013, in the Korean Intellectual Property Office, the disclosure of which is incorporated by reference herein in its entirety.

### TECHNICAL FIELD

The present invention relates to an apparatus and a method for determining a substrate, and a method for manufacturing a flexible display using the same, and more particularly, to an apparatus for determining a base substrate and a flexible substrate, a method for determining the base substrate and the flexible substrate, and a method for manufacturing a flexible display using the same.

### DISCUSSION OF THE RELATED ART

Examples of flat panel displays may include a liquid crystal display (LCD), a plasma display panel (PDP), an organic light emitting display (OLED), or the like. Most of the existing LCD, PDP, or OLED display panels are formed with rigid glass substrates which are inflexible.

To make a flexible display, a flexible substrate is required. However, it may be difficult to apply a flexible substrate instead of the glass substrate.

### SUMMARY

Therefore, the present invention has been made in an effort to provide a substrate determination apparatus. This apparatus may determine a base substrate and a flexible substrate by detecting optical information of the base substrate and the flexible substrate.

The present invention has also been made in an effort to provide a substrate determination method. This method may determine a base substrate and a flexible substrate by detecting optical information of the base substrate and the flexible substrate.

The present invention has also been made in an effort to provide a method for manufacturing a flexible display. This method may decrease a fault rate and increase productivity by determining a base substrate and a flexible substrate during a process.

According to an aspect of the present invention, an apparatus for determining a substrate is provided. The apparatus includes a light emitting unit, a light receiving unit, a memory unit, and a control unit. The light emitting unit is configured to emit light onto one surface of the substrate. The light receiving unit is configured to receive the light reflected from the one surface of the substrate, and to detect optical information. The memory unit is configured to store the optical information of the received light and a reference value. The control unit is configured to determine whether the one surface of the substrate is a first surface or a second surface of the substrate by comparing the optical information and the reference value.

According to an aspect of the present invention, a method for determining a substrate is provided. The method includes preparing a substrate including a first surface and a second surface having different optical properties, detecting optical information on one of the first surface and the second surface of the substrate, and determining whether the one of the first surface and the second surface of the substrate is the first surface or the second surface of the substrate by comparing the optical information and a stored reference value.

According to an aspect of the present invention, a method for manufacturing a flexible display is provided. The method includes forming a substrate including a first substrate and a second substrate attached on the first substrate, detecting optical information on one of the first substrate and the second substrate, determining the one of the first substrate and the second substrate based on the optical information, comparing the determined one of the first substrate and the second substrate with a process target substrate, and separating the first substrate and the second substrate.

According to an aspect of the present invention, a method for determining a substrate is provided. The method includes detecting optical information on one of both surfaces of the substrate and determining whether the one of both surfaces of the substrate is a first surface or a second surface of the substrate based on the optical information. The both surfaces of the substrate have different optical properties. The optical information is obtained by analyzing light reflected on the one of both surfaces of the substrate.

According to embodiments of the present invention, the following effect may be at least obtained.

That is, by determining a stacking sequence of a base substrate or a flexible substrate, a process fault rate and a process facility malfunction may be reduced, and as a result, productivity may be increased.

The effects of the present invention are not limited to the aforementioned effects, and other effects, which are not mentioned above, will be apparently understood by those skilled in the art from the recitations of the claims.

### BRIEF DESCRIPTION OF THE DRAWINGS

The above and other features of the present invention will become more apparent by describing in detail embodiments thereof with reference to the attached drawings in which:

FIG. 1 is a schematic view of a substrate and an apparatus of determining the substrate according to an embodiment of the present invention;

FIG. 2 is a schematic view illustrating a configuration of a substrate determination apparatus and a substrate according to an embodiment of the present invention;

FIG. 3 is a schematic view illustrating a light emitting unit and a light receiving unit of a substrate determination apparatus according to an embodiment of the present invention;

FIG. 4 is a schematic view illustrating a light emitting unit and a light receiving unit of a substrate determination apparatus according to an embodiment of the present invention;

FIG. 5 is a schematic view illustrating intensities of light emitted from the light emitting unit according to an embodiment of the present invention;

FIG. 6 is a schematic view illustrating intensities of light received by the light receiving unit according to an embodiment of the present invention;

FIG. 7 is a schematic view illustrating a configuration of a substrate determination apparatus and a substrate according to an embodiment of the present invention;

FIG. 8 is a flowchart of a method for determining a substrate according to an embodiment of the present invention;

FIG. 9 is a schematic view illustrating preparing a substrate in the method for determining a substrate according to an embodiment of the present invention;

FIG. 10 is a schematic view illustrating detecting optical information in the method for determining a substrate according to an embodiment of the present invention;

FIG. 11 is a flowchart illustrating a manufacturing method for a flexible display according to an embodiment of the present invention;

FIG. 12 is a flowchart illustrating forming a substrate combination body in a manufacturing method for a flexible display according to an embodiment of the present invention;

FIG. 13 is a cross-sectional view of a substrate in a manufacturing method for a flexible display according to an embodiment of the present invention;

FIG. 14 is a flowchart illustrating determining a substrate in a manufacturing method for a flexible display according to an embodiment of the present invention;

FIG. 15 is a schematic view illustrating a change in layout of a substrate in a manufacturing method for a flexible display according to an embodiment of the present invention; and

FIG. 16 is a cross-sectional view illustrating separating a substrate in a manufacturing method for a flexible display according to an embodiment of the present invention.

### DETAILED DESCRIPTION OF THE EMBODIMENTS

Features of the present invention may be understood more readily by reference to the following detailed description of embodiments and the accompanying drawings. The present invention may, however, be embodied in various forms and should not be construed as being limited to the embodiments set forth herein. Like reference numerals may refer to like elements throughout the specification.

Hereinafter, embodiments of the present invention will be described with reference to the accompanying drawings.

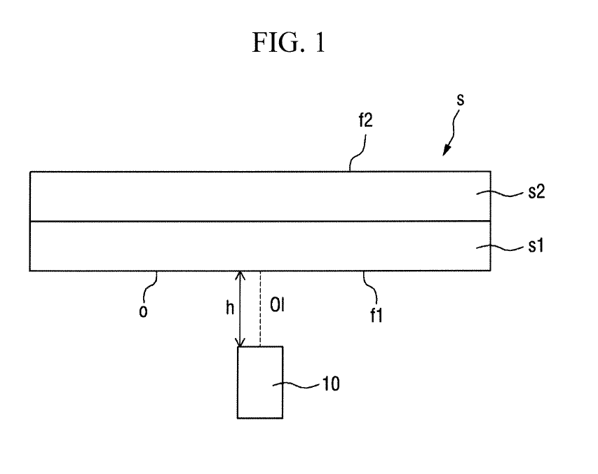

FIG. 1 is a schematic view of a substrate determination apparatus and a substrate according to an embodiment of the present invention.

Referring to FIG. 1, a substrate s may be a laminated substrate formed by attaching two substrates having different materials and properties. Two substrates may be a first substrate s1 and a second substrate s2. Each of the two substrates has two surfaces. The substrate s may include a first substrate s1 and a second substrate s2 attached on one surface of the first substrate s1. The one surface of the first substrate s1 and one surface of the second substrate s2 may be combined to each other with an adhesive layer (not illustrated) interposed between the one surface of the first substrate s1 and the one surface of the second substrate s2.

The first substrate s1 may be a base substrate and the second substrate may be a flexible substrate.

The first substrate s1 may be made of a non-flexible insulating material such as glass. The second substrate s2 may be made of flexible materials such as kapton, polyethersulphone (PES), polycarbonate (PC), polyimide (PI), polyethyleneterephthalate (PET), polyethylenenaphthalate (PEN), polyacrylate (PAR), fiber reinforced plastic (FRP), or the like.

Since the substrate s is formed by laminating the two substrates s1 and s2 having different materials and properties, a first surface f1 and a second surface f2 of the substrate s may have different optical properties from each other. Herein, the first surface f1 of the substrate s may be formed by the other surface of the first substrate s1 and the second surface f2 of the substrate s may be formed by the other surface of the second substrate s2. Attributing to the different optical property between the first substrate s1 and the second substrate s2, it may be determined whether the first surface f1 of the substrate s (e.g., a surface positioned below the substrate s) is the surface of the first substrate s1 or the surface of the second substrate s2. Therefore, locations and sequences in which the first substrate s1 and the second substrate s2 are laminated may be verified.

A substrate determination apparatus 10 may be disposed to be spaced apart from the substrate s. One of the first surface f1 and the second surface f2 of the substrate s may be disposed to face the substrate determination apparatus 10. In the drawing, it is exemplified that a surface o of the substrate s that faces the substrate determination apparatus 10 is the first surface f1 of the substrate s formed by the other surface of the first substrate s1, however, the facing surface o of the substrate s may be the second surface f2 of the substrate s foamed by the other surface of the second substrate s2.

The substrate determination apparatus 10 may obtain optical information OI from the faced surface o of the substrate s. The substrate determination apparatus 10 may determine whether the facing surface o of the substrate o is the first surface f1 or the second surface f2 based on the optical information OI, and as a result, the substrate determination apparatus 10 may determine whether the faced substrate of the substrate s is the first substrate s1 or the second substrate s2.

Referring to FIG. 1, the substrate determination apparatus 10 may be disposed to be spaced apart from the facing surface o of the substrate s by a predetermined interval h. The interval h may be 5 mm to 50 mm. FIG. 1, illustrates that one substrate determination apparatus 10 detects the optical information OI of the first substrate s1 or the second substrate s2, but an embodiment of the present invention is not limited thereto and in the case of a substrate determination apparatus according to an embodiment of the present invention, a plurality of substrate determination apparatuses may detect the optical information OI of the substrate s.

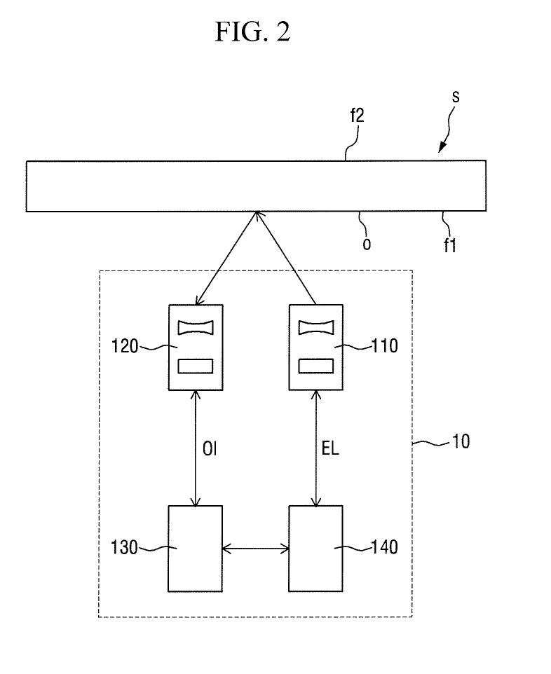

Hereinafter, a configuration of the substrate determination apparatus 10 will be described in more detail with reference to FIG. 2.

FIG. 2 is a schematic view illustrating a configuration of the substrate determination apparatus and the substrate according to an embodiment of the present invention.

The substrate determination apparatus 10 may include a light emitting unit 110, a light receiving unit 120, a memory unit 130, and a control unit 140. The light emitting unit 110 may emit light toward the facing surface o of the substrate s according to a light emitting signal EL input from the control unit 140. A portion of the emitted light may be absorbed in the facing surface o of the substrate s, and other portions of the emitted light may be reflected on the facing surface o of the substrate s. The facing surface o may be the first surface f1 of the substrate s or the other surface f2 of the substrate s according to a layout direction of the substrate s. As described above, since the optical properties of the first surface f1 and the second surface f2 of the substrate s are different from each other, a frequency, a phase, a wavelength, and an intensity of the reflected light may vary depending on whether the facing surface o of the substrate s is the first surface f1 or the second surface f2.

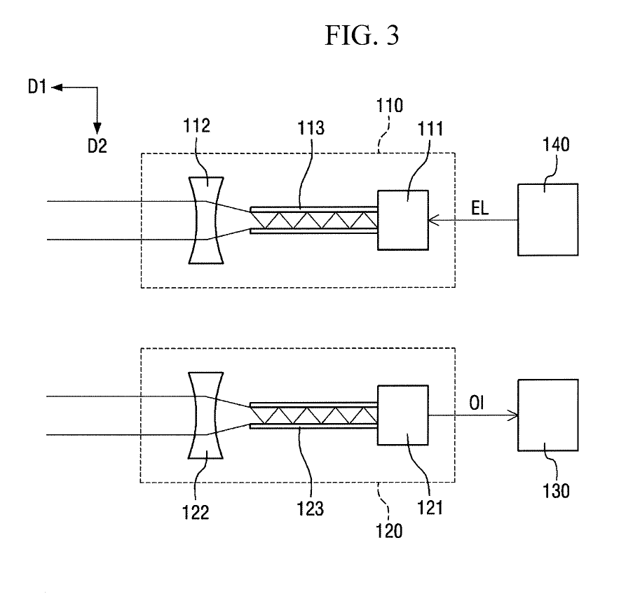

The light receiving unit 120 may receive the light reflected on the facing surface o. The light receiving unit 120 may analyze the received light to generate analyzed optical information OI which is an electric signal. The optical information OI may be a numerical value that corresponds to the frequency, the phase, the wavelength, or the intensity of the light reflected on the facing surface o. Therefore, values of the optical information OI reflected when the facing surface o of the substrate s is the first surface f1 of the substrate s and the second surface f2 of the substrate s may be different from each other. The light receiving unit 120 may transmit the optical information OI to the memory unit 130. The light emitting unit 110 and the light receiving unit 120 may be formed by optical fiber sensors including optical fiber cables. More detailed description will be made with reference to FIG. 3.

FIG. 3 is a schematic view illustrating a light emitting unit and a light receiving unit of the substrate determination apparatus according to an embodiment of the present invention.

As illustrated in FIG. 3, the light emitting unit 110 and the light receiving unit 120 may further include optical fiber cables 113 and 123.

The light emitting unit 110 may include a light emitting element 111, a light emitting lens 112, and a light emitting cable 113. The light emitting element 111 may be a self-emitting light source such as a light emitting diode. The light emitted from the light emitting element 111 may be a visible ray having a wavelength in the range of 380 nm to 750 nm or an infrared ray having a wavelength of 750 nm or more. The light emitting element 111 may emit light according to the light emitting signal EL input from the control unit 140.

One end of the light emitting cable 113 may be connected with the light emitting element 111 and the other end thereof may be connected with the light emitting lens 112. Therefore, the light emitting cable 113 may transmit the light emitted from the light emitting element 111 to the light emitting lens 112. The light emitting cable 113 has a structure in which a material layer having a high refractive index and a material layer having a low refractive index are laminated. Therefore, the light emitted from the light emitting element 111 may meet a condition of total reflection, and as a result, travel along the light emitting cable 113 by minimizing a transmission loss of the light. Thus, even though the light emitting element 111 and the light emitting lens 112 are distant from each other, the light may be efficiently transmitted. Further, the light emitting cable 113 is flexible, and thus, allows the substrate determination apparatus 10 to be freely disposed without a limitation at any place.

The light emitting lens 112 may be, for example, a concave lens. The light emitting lens 112 may convert the light transmitted from the light emitting unit 110 into the light which is parallel to a first direction D1. A portion of the light emitted through the light emitting lens 112 may travel to the facing surface o of the substrate s, and absorbed in the facing surface o of the substrate s. Other portions of the emitted light may be reflected on the facing surface o. The lighted reflected on the facing surface o may travel back to the light receiving unit 120 in a direction opposite to the first direction D1. The light emitting unit 110 may further include a light emitting fiber (not illustrated) disposed between the light emitting lens 112 and the light emitting cable 113. The light emitting fiber (not illustrated) may uniformize light transmitted to increase an efficiency of luminance.

Further, the substrate determination apparatus 10 may further include a light blocking layer (not illustrated) disposed between the light emitting unit 110 and the light receiving unit 120 to reduce an interference between the emitted light and the received light.

The light receiving unit 120 may include a light receiving element 121, a light receiving lens 122, and a light receiving cable 123. The light receiving lens 122 may collect the received light to transmit the collected light to the light receiving cable 123. The concave lens may be adopted as the light receiving lens 122, but an embodiment of the present invention is not limited thereto. The light receiving cable 123 may transmit the light to the light receiving element 121. The light transmitted to the light receiving element 121 may meet the condition of total reflection as in the light emitting cable 113. The light emitting element 121 may analyze optical properties of the light that is received through the light receiving cable 123 to generate optical information OI, and thus transmit the optical information OI to the memory unit 130. The optical properties of the received light may include a wavelength, a phase, and an intensity of the received light. The optical information OI may be an electric signal.

Referring back to FIG. 2, the memory unit 130 may include a random access memory (RAM) and a read only memory (ROM). The RAM of the memory unit 130 may temporarily store the optical information OI transmitted from the light receiving unit 120. Further, the RAM may provide a working area and a reading condition table area required for an arithmetic operation or a logic operation. The ROM of the memory unit 130 may store various types of operation process programs or substrate determination programs. The substrate determination program may include a reference value SV for distinguishing the first surface f1 and the second surface f2 of the substrate s. The reference value SV may be calculated based on a measurement value of the optical information OI. The measurement value of the optical information OI may be accumulated with respect to the first surface f1 and the second surface f2 of the substrate s.

The control unit 140 may perform an operation-related work, an overall control, and a substrate determination work of the substrate determination apparatus 10. The control unit 140 may compare the optical information OI of the facing surface o and the reference value SV to determine whether the optical information OI of the facing surface o is the optical information OI of the first surface f1 or the second surface f2 of the substrate s. For example, when the optical information OI of the facing surface o is less than the reference value SV, the control unit 140 may determine that the facing surface o is the first surface f1. For example, when the optical information OI of the facing surface o is equal to the reference value SV or more, the control unit 140 may determine that the facing surface o is the second surface f2. When the control unit 140 determines whether the facing surface o is the first surface f1 or the second surface f2 of the substrate s, the control unit 140 may determine whether the substrate that faces the substrate determination apparatus 10 is the first substrate s1 or the second substrate s2. Therefore, locations and sequences in which the first substrate s1 and the second substrate s2 are laminated may be verified. The control unit 140 may provide a substrate determination result to a user.

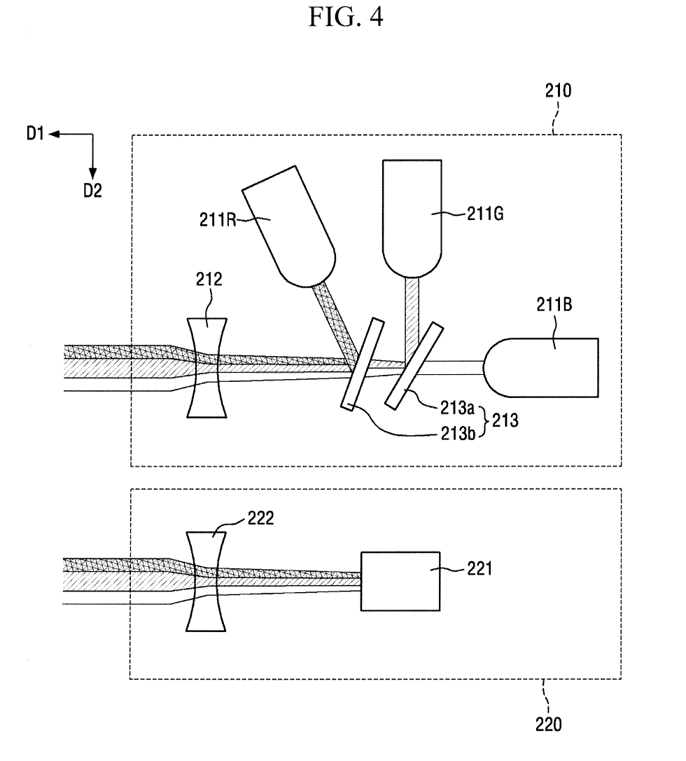

FIG. 4 is a schematic view illustrating a light emitting unit and a light receiving unit of a substrate determination apparatus according to an embodiment of the present invention.

Referring to FIG. 4, a light emitting unit 210 of a substrate determination apparatus according to an embodiment of the present invention may include light emitting elements 211R, 211G, and 211B, a light emitting lens 212, and light emitting mirrors 213a and 213b. The light emitting elements 211R, 211G, and 211B may generate a red light, a green light, and blue light, respectively. Also, each of the light emitting elements 211R, 211G, and 211B may include a light emitting diode that emits the light by itself. For example, the red emitting element 211R may be created by using a PN-junction of gallium arsenide (GaAs). The green emitting element 211G may be created by adding Zn and O as impurities to gallium phosphide (GaP). The blue emitting element 211B may be created by epitaxially growing gallium nitride (GaN). Each of the light emitting elements 211R, 211G, and 211B may be disposed at different locations in the light emitting unit 210. The layout of the light emitting elements 211R, 211G, and 211B illustrated in FIG. 4 is an example and an embodiment of the present invention is not limited thereto. The blue emitting element 211B may emit a blue light toward a first emission mirror 213a in the first direction D1 and the green emitting element 211G may emit a green light toward the first emission mirror 213a in a second direction D2. The first emission mirror 213a may not mix the blue light and the green light, but divide the blue light and the green light to travel each light toward a second emission mirror 213b in the first direction D1. The red emitting element 211R may emit a red light toward the second emission mirror 213b. The second emission mirror 213b may propagate the blue light, the green light, and the red light toward the light emitting lens 212 in the first direction D1 without mixing or scattering them. For example, the concave lens may be adopted as the light emitting lens 212. The light emitting lens 212 may convert the transmitted blue light, green light, and red light to be parallel to the first direction of D1.

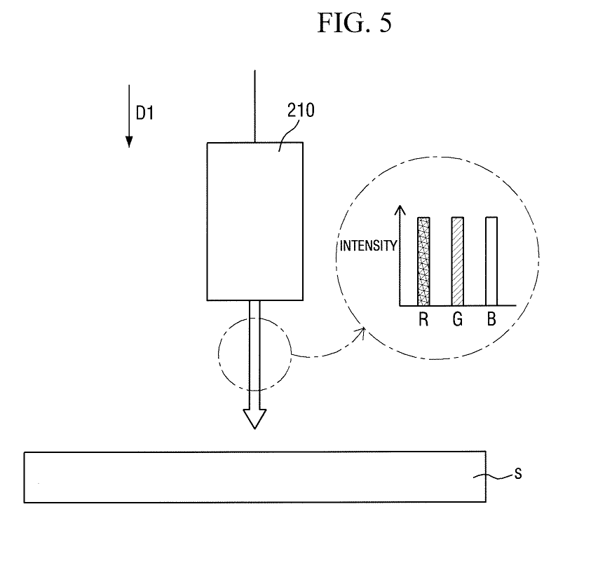

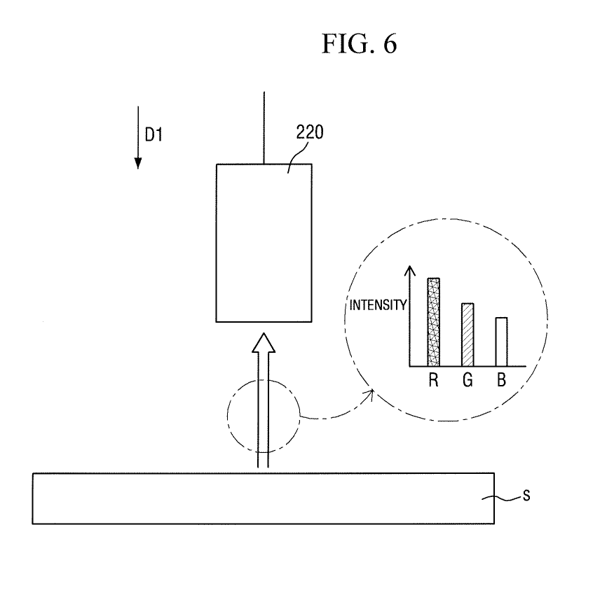

FIG. 5 is a schematic view illustrating intensities of different colors light emitted from the light emitting unit according to an embodiment of the present invention. FIG. 6 is a schematic view illustrating intensities of different colors of the light received by the light receiving unit according to an embodiment of the present invention.

Referring to FIG. 5, the light emitted from the light emitting unit 210 may travel toward the substrate s in the first direction D1 and the emitted light may include a red light, a green light, and a blue light. Further, the intensities of the red light, the green light, and the blue light may be the same as each other, and as a result, the ratios in intensity of the red light, the green light, and the blue light may be the same as each other.

Referring to FIG. 6, the light reflected on the substrate s may travel back toward the light receiving unit 220 in a direction opposite to the first direction D1 and the reflected light may include a red light, a green light, and a blue light. However, an amount of the light absorbed in the substrate s may vary depending on a wavelength of each of the red light, the green light, and the blue light, and as a result, an amount of the reflected light may vary for the wavelength of each of the red light, the green light, and the blue light. Since the amount of the reflect light is proportional to an intensity of the reflected light, the intensity of the reflected light may vary for the wavelength of each of the red light, the green light, and the blue light, as illustrated in FIG. 6. Furthermore, since the first surface f1 and the second surface f2 of the substrate s have different optical properties, the light reflected on the first surface f1 and the light reflected on the second surface f2 may have different ratios in intensity of the red light, the green light, and the blue light. Therefore, a difference in ratio of intensity of the red light, the green light, and the blue light may be used as optical information OI that determines the first surface f1 and the second surface f2 in a substrate determination apparatus 20 according to an embodiment of the present invention.

The light receiving unit 220 may include at least one three-primary-color (RGB) light receiving element 221 and a light receiving lens 222. The light receiving lens 222 may collect the received light, and transmit the collected light to the light receiving element 221. The at least one three-primary-color (RGB) light receiving element 221 may analyze the received light to generate analyzed optical information OI which is an electric signal. The optical information OI may relate to the ratios in intensity of the red light, the green light, and the blue light, and may be data digitized by reflecting the ratios. The optical information OI obtained by reflecting the difference in light intensity or the ratio of three primary colors may distinguish the first surface f1 and the second surface f2. The at least one three-primary-color light receiving element 221 may transmit the optical information OI to the memory unit 230.

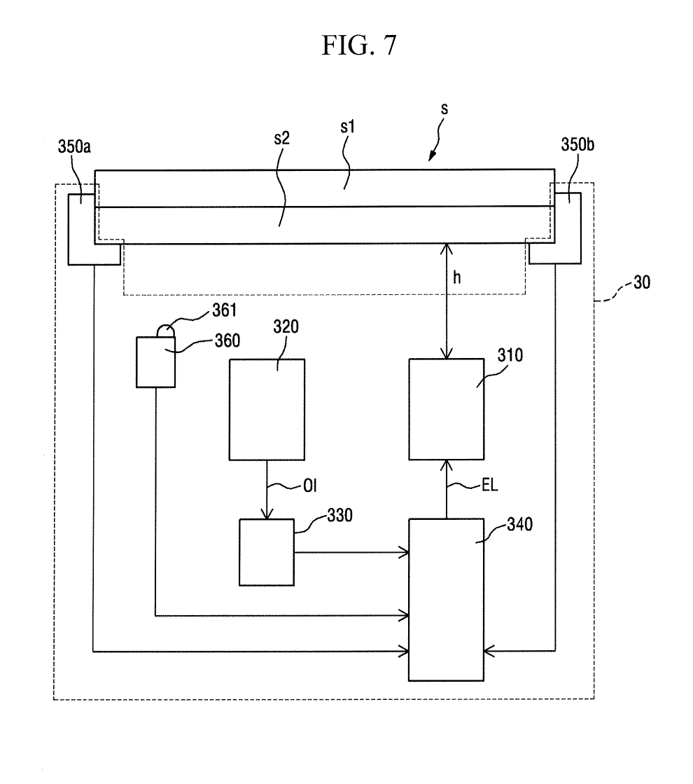

FIG. 7 is a schematic view illustrating a configuration of a substrate determination apparatus and a substrate according to an embodiment of the present invention.

Referring to FIG. 7, a substrate determination apparatus 30 according to an embodiment of the present invention may further include a fixing member 350 that fixes a substrate s to a substrate reading unit 360 that reads the substrate s.

The fixing member 350 may include a first fixing member 350a and a second fixing member 350b. The first fixing member 350a and the second fixing member 350b may fix one end and the other end of the substrate s, respectively, and maintain a predetermined distance h between the substrate determination apparatus 30 and the substrate s. The distance h may be a predetermined distance in which the substrate determination apparatus 30 emits light to the substrate s and receives reflected light from the substrate s. efficiently. The predetermined distance h may be 5 mm to 50 mm. That is, the fixing member 350 may fix a condition for the substrate determination and help the substrate determination apparatus's detection of the optical information OI. The fixing member 350 may be integrated with the substrate determination apparatus 30, or may be formed during a flexible display facility process. When the substrate s is fixed to the fixing member 350, the fixing member 350 may transfer a substrate fixing signal to a control unit 340.

The substrate reading unit 360 may read whether the substrate s to be determined is mounted on the process facility. The substrate reading unit 360 may be a sensor. That is, the substrate reading unit 360 may read whether the substrate s is mounted by detecting light reflected by the mounted substrate s. When the substrate s is read, the substrate reading unit 360 may alarm a user by turning on an alarm lamp 361 that the substrate s is read. Further, when the substrate s is read, the substrate reading unit 360 may transfer a substrate reading signal to the control unit 340 that the substrate s is read.

The control unit 340 may receive the substrate fixing signal from the fixing member 350 and the substrate reading signal from the substrate reading unit 360, and thereafter, may transmit a light emitting signal EL that instructs a light emitting unit 310 to emit light in response to the signal EL. The fixing member 350 and the substrate reading unit 360 may increase efficiency and accuracy of the substrate determination apparatus 30 because they provide sequential and constant processes to determine the substrate s after the substrate s is completely mounted.

Since the other configurations of the substrate determination apparatus 30 are substantially the same as those of the substrate determination apparatus 10, a description of similar features may be omitted.

Hereinafter, a method for determining a substrate according to an embodiment of the present invention will be described.

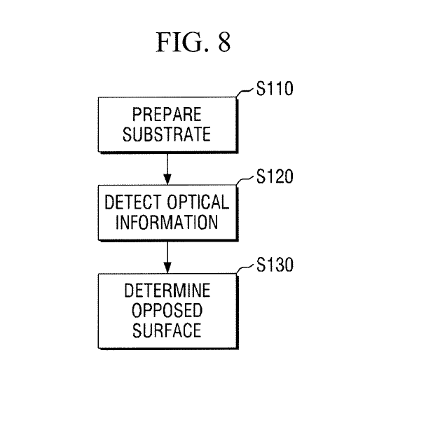

FIG. 8 is a flowchart of a method for determining a substrate according to an embodiment of the present invention.

As illustrated in FIG. 8, the method for determining a substrate according to an embodiment of the present invention may include: preparing a substrate including a first surface and a second surface having different optical properties (S110); detecting optical information on a facing surface of the substrate (S120); and determining whether the facing surface is the first surface or the second surface of the substrate (S310). The substrate may have two surfaces.

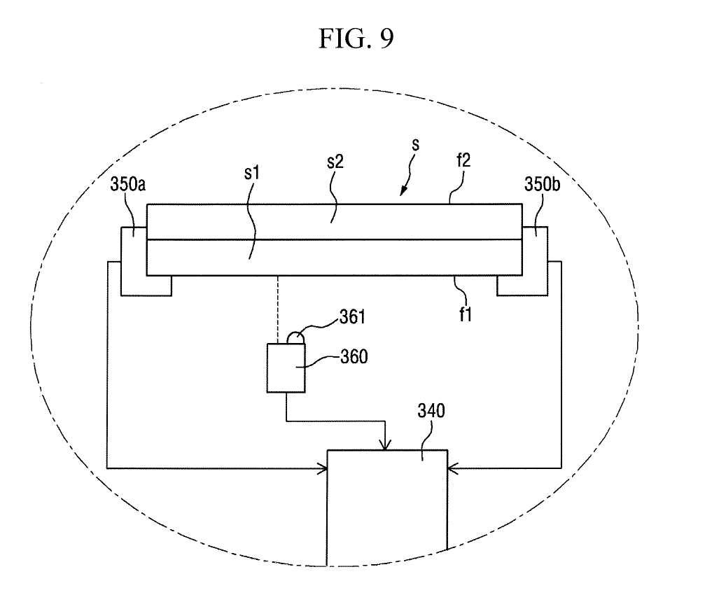

First, the substrate may be prepared (S110). The step will be described in more detail with reference to FIG. 9.

FIG. 9 is a schematic view illustrating preparing a substrate in the method for determining a substrate according to an embodiment of the present invention.

The substrate may be a laminated substrate formed by attaching two substrates having different materials and properties. That is, the substrate s may include a first substrate s1 and a second substrate s2 attached on one surface of the first substrate s1. The first substrate s1 may serve as a base substrate to fix the second substrate s2 without being twisted during the process. For example, the first substrate s1 may be a non-flexible substrate including an insulating material such as glass and the second substrate s2 may be a flexible substrate.

Since the substrate s is formed by laminating two substrates s1 and s2 having different materials and properties, a first surface f1 and a second surface f2 of the substrate s may have different optical properties. Herein, the first surface f1 of the substrate s may be formed by the one surface of the first substrate s1, and the second surface f2 of the substrate s may be formed by the one surface of the second substrate s2. When a difference in optical property between the first substrate s1 and the second substrate s2 is used, it may be determined whether one side of the substrate s (e.g., a surface positioned below the substrate s) is the surface of the first substrate s1 or the surface of the second substrate s2.

In the preparing of a substrate (S110), the substrate s may be fixed by a fixing member 350. A first fixing member 350a and a second fixing member 350b may fix one end and the other end of the substrate s, respectively, and maintain a predetermined interval h between the substrate s and the substrate determination apparatus 30. Further, the fixing member 350 may transfer a substrate fixing signal to a control unit 340 when the substrate s is fixed.

In the preparing of a substrate (S110), a substrate reading unit 360 may read the substrate s. The substrate reading unit 360 may read whether the substrate s to be determined is mounted on process facility. When the substrate s is read by a sensor, the substrate reading unit 360 may notify a user by turning on an alarm lamp 361 that the substrate s is read, and transfer a substrate reading signal of the substrate s to a control unit 340.

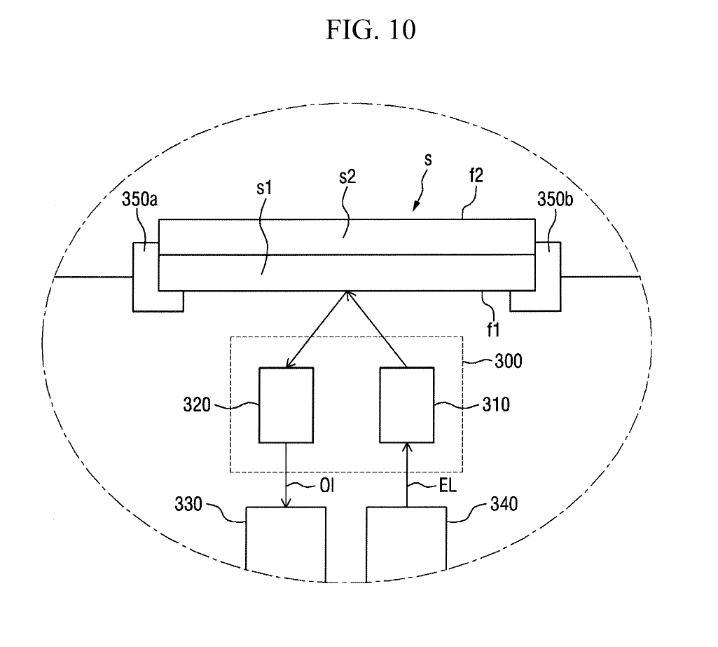

Subsequently, optical information on the facing surface of the substrate is detected (S120). This process will be described in more detail with reference to FIG. 10.

FIG. 10 is a schematic view illustrating detecting optical information in the method for determining a substrate according to an embodiment of the present invention.

The control unit 340 that receives the substrate fixing signal from the fixing member 350 and the substrate reading signal of the substrate reading unit 360 may transfer a light emitting signal EL to a light emitting unit 310. The light emitting unit 310 may emit light onto the facing surface o of the substrate s in response to the light emitting signal EL. The facing surface o to which the emitted light travel may be the first surface f1 of the substrate s or the second surface f2 of the substrate s. A portion of the emitted light may be absorbed in the facing surface o and other portions of the emitted light may be reflected on the facing surface o to be received by a light receiving unit 320. The light receiving unit 320 may convert the received light into optical information OI, and transmit the optical information to a memory unit 330. The light emitting unit 310 and the light receiving unit 320 may formed by optical fiber sensors including optical fiber cables. In this case, the optical information OI may be a numerical value that corresponds to a frequency, a phase, a wavelength, and an intensity of the light reflected on the facing surface o. Further, in an embodiment of the present invention, the light emitting unit 310 may include three-primary-color (RGB) light emitting elements and the light receiving unit 320 may include at least one three-primary-color (RGB) light receiving element. In this case, the optical information OI may be data digitized by reflecting respective ratios of red light, green light, and blue light. The optical information OI may vary depending on whether the facing surface o is the first surface f1 or the second surface f2, and accordingly, it may be determined whether the facing surface o is the first surface f1 or the other surface f2 by a difference in optical information OI.

Subsequently, the facing surface may be determined (S130). The control unit 340 may compare the optical information OI stored in the memory unit 330 and a reference value SV to determine whether the optical information OI is the optical information OI of the first surface f1 or the second surface f2.

For example, when the optical information OI of the facing surface o is less than the reference value SV, the control unit 140 may determine that the facing surface is the surface f1. For example, when the optical information OI of the facing surface o is equal to the reference value SV or more, the control unit 140 may determine that the facing surface o is the second surface f2. When the control unit 140 determines whether the facing surface o is the first surface f1 or the second surface f2 of the substrate s, the control unit 140 may determine whether the substrate that faces the substrate determination apparatus 10 is the first substrate s1 or the second substrate s2. Therefore, locations and sequences in which the first substrate s1 and the second substrate s2 are laminated may be verified. The control unit 140 may provide a substrate determination result to a user.

Hereinafter, a method for manufacturing a flexible display using the substrate determination method will be described.

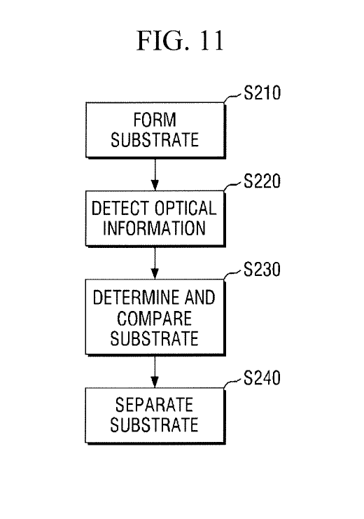

FIG. 11 is a flowchart illustrating a method for manufacturing a flexible display according to an embodiment of the present invention.

Referring to FIG. 11, the method for manufacturing a flexible display may include: forming a substrate including a first substrate and a second substrate attached on one surface of the first substrate (S210); detecting optical information on a substrate that faces a substrate determination apparatus (S220); determining and comparing the facing substrate (S230); and separating the first substrate and the second substrate (S240).

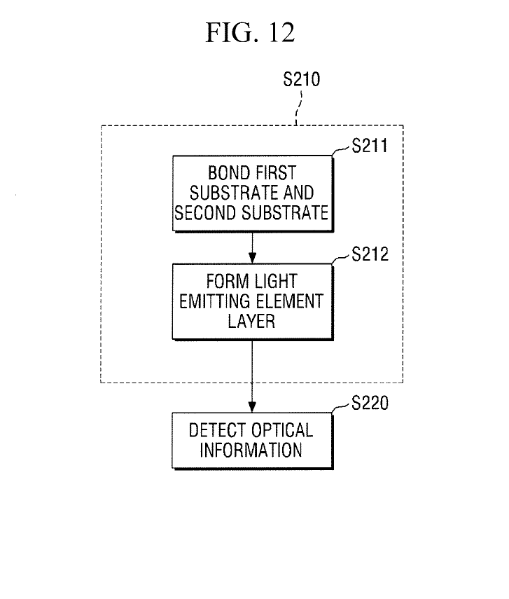

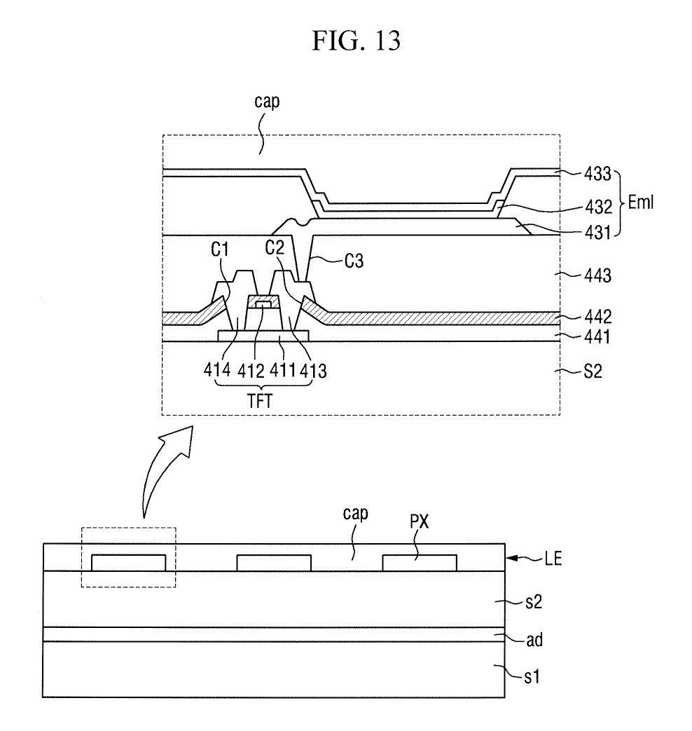

First, the substrate may be formed (S210). This process will be described in detail with reference to FIGS. 12 and 13.

FIG. 12 is a flowchart illustrating forming a substrate in the method for manufacturing a flexible display according to an embodiment of the present invention, and FIG. 13 is a cross-sectional view of the substrate in the method for manufacturing a flexible display according to an embodiment of the present invention.

Referring to FIGS. 12 and 13, the forming of a substrate (S210) may include: bonding the first substrate and the second substrate (S211); and forming a light emitting element layer on the second substrate (S212).

The first substrate s1 and the second substrate s2 may be bonded to each other (S211). The first substrate s1 and the second substrate s2 may be bonded to each other to form a substrate s. The first substrate s1 may be a non-flexible substrate, and the second substrate s2 may be a flexible substrate. Since the first substrate s1 and the second substrate s2 have been described above, the description thereof will be omitted. The substrate s may further include an adhesive layer ad interposed between the first substrate s1 and the second substrate s2. The adhesive layer ad may fix the second substrate s2 to the first substrate s1. The adhesive layer ad may be made of a light transmissive material. Further, the adhesive layer ad may have a transmittance to pass a laser beam having a specific wavelength. The adhesive layer may have a heat resistance in which a glass transition temperature is 220° C. or higher. For example, the adhesive layer ad may include a polymer adhesive such as silicon, polysilicon, or an acryl-based material. The adhesive layer ad may be formed on the first substrate s1 or the second substrate s2 by a printing method, a slit coating method, a spin coating method, a dipping method, or the like. Since features and materials of the first substrate s1 and the second substrate s2 have been described above, the description thereof will be omitted.

Subsequently, a light emitting element layer LE is formed on the second substrate s2 (S212). As illustrated in FIG. 13, the light emitting element layer LE may include a plurality of pixels PX and a capping layer cap protecting the pixels PX. When the light emitting element layer LE is formed, the pixel PX may be formed earlier than the capping layer cap, and thereafter, the capping layer cap may be formed on the pixel PX.

The pixel PX may be formed on the second substrate s2. The pixel PX may include a thin film transistor Tr and a light emitting layer Eml. The thin film transistor Tr may include a semiconductor layer 411, a gate electrode 412, a drain electrode 413, and a source electrode 414.

The thin film transistor Tr may be formed by sequentially laminating the semiconductor layer 411, a first insulating layer 441, the gate electrode 412, a second insulating layer 442, the source and drain electrodes 414 and 413, and a third insulating layer 443 on the second substrate s2. The semiconductor layer 411, a first insulating layer 441, the gate electrode 412, a second insulating layer 442, the source and drain electrodes 414 and 413, and a third insulating layer 443 may be formed by a photolithography process using a photomask. The photolithography process may be performed through a series of processes such as developing, etching, and stripping or ashing after exposure by an exposure apparatus (not illustrated).

The semiconductor layer 411 may be amorphous silicon or poly silicon. The first insulating layer 441 formed on the semiconductor layer 411 may be made of an inorganic material such as SiNx, SiO₂, SiON, Al₂O₃, or TiO₂. However, a material making the first insulating layer 441 is not limited thereto. For example, the first insulating layer 441 may be made of an organic material. The gate electrode 412 may be a transparent conductive oxide including at least one material that is selected from a group including ITO, IZO, ZnO, and In₂O₃. The second insulating layer 442 may be made of the same material as the first insulating layer 441. The source and drain electrodes 414 and 413 may be electrically connected with the semiconductor layer 411 through first and second contact holes C1 and C2 foamed on the second insulating layer 442. The third insulating layer 443 may be made of organic insulating materials such as a general common-use polymer (PMMA) PS, a polymer derivative having a phenol group, an acryl-based polymer, an imide-based polymer, an arylether-based polymer, an amide-based polymer, a fluorinate polymer, a p-xylene-based polymer, a vinyl alcohol-based polymer, or blends thereof.

The source electrode 414 of the thin film transistor Tr may be connected with a data signal (not illustrated), and the drain electrode 413 of the thin film transistor Tr may be connected with a first electrode 431 of the light emitting layer Eml. The semiconductor layer 411 may be electrically connected with the source electrode 414 through the first contact hole C1, and connected electrically connected with the drain electrode 413 through the second contact hole C2. When a voltage is applied to the gate electrode 412 of the thin film transistor Tr, the semiconductor layer 411 may be activated. The activated semiconductor layer 411 may electrically connect the source electrode 414 and the drain electrode 413, and transfer a current corresponding to a data signal of the source electrode 414 to the first electrode 431 through the drain electrode 413. That is, the thin film transistor Tr may control the data signal to be transferred to the first electrode 431 of the light emitting layer Eml.

The light emitting layer Eml may include the first electrode 431, a light emitting material 432, and a second electrode 433. The first electrode 431 may be an anode electrode and the second electrode 433 may be a cathode electrode.

The first electrode 431 may be formed on the third insulating layer 443. The first electrode 431 may be electrically connected with the drain electrode 413 through a third contact hole C3, and receive a current from the drain electrode 413. The first electrode 431 may be a material having a high work function. For example, the first electrode 431 may be a transparent conductive material such as ITO or IZO, or a metal oxide such as an aluminum oxide (Al₂O₃) or a zinc oxide (ZnO).

An organic layer 432 may be formed on the first electrode 431. The organic layer 432 may be formed by laminating a hole injection layer (HIL), a hole transport layer (HTL), an organic emissive layer (EML), an electron transport layer (ETL), an electron injection layer (EIL), and the like in a single or a hybrid structure. The organic layer 432 may emit light with a brightness corresponding to the current transferred to the first electrode 431. In more detail, when a hole and an electron are provided to the organic layer 432, the hole and the electron are combined with each other to form an exciton. An energy level of the exciton may vary from an excitation state to a ground state, and light having a color corresponding to the varied energy level may be emitted. The organic layer 432 may emit one of the colors of red, blue, and green. A light emitting material of the organic layer 432 may be organic materials such as copper phthalocyanine (CuPc), N,N′-di(naphthalene-1-yl)-N,N′-diphenyl-benzidine (NPB), or tris-8-hydroxyquinoline aluminum (Alq₃).

The second electrode 433 may be formed on the organic layer 432. The second electrode 433 may form an electric field together with the first electrode 431 to allow the organic layer 432 to emit the light. The second electrode 433 may be a metal having a low work function. The metal may include Mg, Ag, Al, Au, or Cr.

Subsequently, the capping layer cap may be disposed on the pixel PX. The capping layer cap may fully cover the second substrate s2 as well as the pixel PX. The capping layer cap may prevent external foreign materials from penetrating the second substrate s2 and the pixel PX. Further, after the first substrate s1 is separated, the capping layer cap may fix the second substrate s2 to prevent the second substrate s2 from being easily bent or twisted. The capping layer cap may include polymer materials such as polyethylenenaphthalate, polyethylene terephthalate, polycarbonate, or polyethersulfone, or a metal foil including stainless steel (SUS).

Referring back to FIG. 11, optical information OI of a substrate opposite to a substrate determination apparatus 30 is detected (S220).

The substrate determination apparatus 30 may emit light to the facing substrate, and receive the light reflected on the facing substrate to detect the optical information OI of the facing substrate. Herein, the facing substrate may be the first substrate s1 or the second substrate s2 according to a layout in the process facility of the formed substrate s and the second substrate s2 may include the pixel PX and the capping layer cap. Since a method of detecting the optical information OI of the substrate by the substrate determination apparatus 30 is substantially the same as the aforementioned optical information detection (S120), a description of similar features may be omitted.

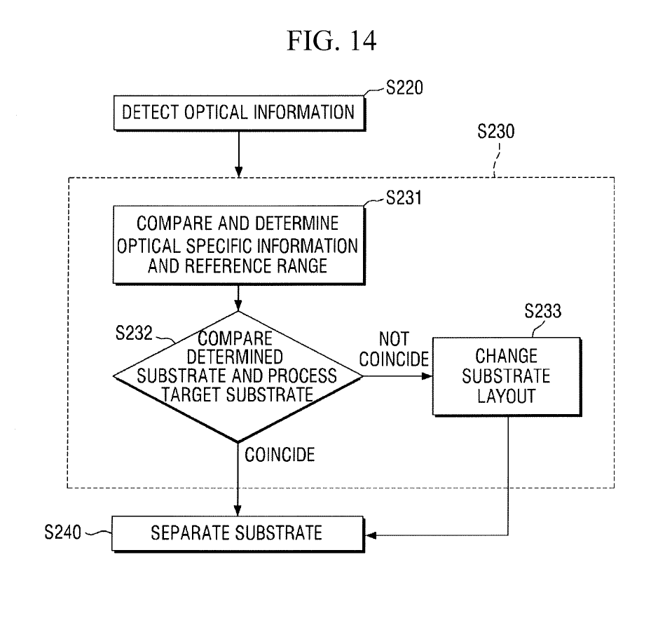

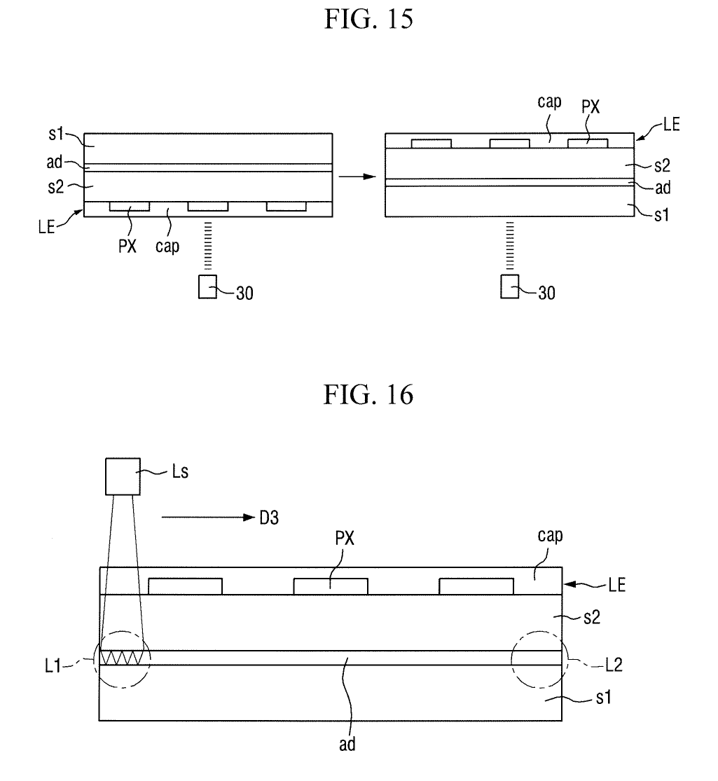

Subsequently, a control unit 340 of the substrate determination apparatus 30 may determine and compare whether the facing substrate is the first substrate s1 or the second substrate s2 (S230). This process will be described in detail with reference to FIGS. 14 and 15.

FIG. 14 is a flowchart illustrating determining and comparing the substrate in the method for manufacturing a flexible display according to an embodiment of the present invention, and FIG. 15 is a schematic view illustrating a change in layout of the substrate in the method for manufacturing a flexible display according to an embodiment of the present invention.

Referring to FIGS. 14 and 15, the determining of the substrate (S230) may include: determining the facing substrate by comparing the optical information OI with a reference value SV (S231); comparing the determined facing substrate with a process target substrate (S232); and changing the layout of the substrate when the determined facing substrate and the process target substrate do not coincide with each other (S233).

First, the control unit 340 of the substrate determination apparatus 30 may compare the optical information OI of the facing substrate and the reference value SV to determine the facing substrate (S231). The reference value SV may be a data value capable of distinguishing the first substrate s1 and the second substrate s2. For example, when the optical information OI of the facing surface is less than the reference value SV, the control unit 340 may determine that the facing surface is the first substrate s1. For example, when the optical information OI of the facing surface is equal to the reference value SV or more, the control unit 340 may determine that the facing surface is the second substrate s2.

Subsequently, the determined facing substrate may be compared with the process target substrate (S232). The control unit 340 may compare the determined facing substrate and the process target substrate with each other. Herein, the determined facing substrate may be the substrate determined in the determining of the facing substrate (S231), and may be the first substrate s1 or the second substrate s2. Herein, the process target substrate may be data on computerization for comparing whether the substrate is accurately disposed in the process facility, and the data may include information of the first substrate s1 or the second substrate s2.

The control unit 340 may compare the determined facing substrate and the process target substrate. When both substrates coincide with each other, the process may proceed to a step of separating the first substrate s1 and the second substrate s2 (S240). However, when the determined facing substrate and the process target substrate do not coincide with each other, the control unit 340 may output a layout change signal of the substrate s to the process facility. The control unit 340 may warn a user that the substrate layout is changed by turning on an alarm lamp. For example, when the process target substrate includes data of the first substrate s1 and the determined facing substrate is the second substrate s2, both substrates do not coincide with each other, and thus, the control unit 340 may stop performing the process and may warn that the substrate layout is changed.

The layout of the substrate may be changed in response to a substrate layout change signal (S233). Referring to FIG. 15, the layout of the substrate may be changed by overturning the substrate that faces the substrate determination apparatus 30, and as a result, the second substrate s2 may be changed to the first substrate s1, or vice versa, and the determined facing substrate and the process target substrate may coincide with each other. The layout of the substrate s may be overturned by a movable member (not illustrated) in the process facility and a user's manual work. The substrate s may be accurately mounted in the process facility by the layout change of the substrate s.

During the manufacturing process of the flexible display, a rate of process fault or process facility malfunction may be reduced and a productivity may be increased by determining the first substrate s1 and the second substrate s2 as described above, comparing the determined facing substrate and the process target substrate to verify whether the substrate s is normally mounted on the process facility.

The first substrate s1 and the second substrate s2 of the properly mounted substrate s may be separated from each other (S240). This process will be described in more detail with reference to FIG. 16.

FIG. 16 is a cross-sectional view illustrating separating a substrate in a method for manufacturing a flexible display according to an embodiment of the present invention.

Referring to FIG. 16, first, a laser beam Ls may be irradiated to the adhesive layer ad disposed between the first substrate s1 and the second substrate s2. The laser beam Ls may be an excimer-based laser beam having a wavelength of 308 nm. However, the laser beam is not limited thereto. The wavelength and intensity of the laser beam Ls may be controlled to prevent the pixel PX and the capping layer cap disposed on the second substrate s2 from being damaged. The laser beam Ls may be irradiated to the adhesive layer ad when it moves in a third direction D3 from a first area L1 to a second area L2 of the adhesive layer ad. The laser beam Ls may be irradiated repeatedly once or more. The irradiation direction of the laser beam Ls may be the third direction or an opposite direction to the third direction. The irradiation of the laser beam Ls may reduce a combination force of the adhesive layer ad or remove the adhesive layer ad, and as a result, the first substrate s1 and the second substrate s2 may be separated from each other. The separated first substrate s1 may be used as a base substrate again through a washing process. The second substrate s2 may be used as a panel of the flexible display.

Although a few embodiments of the present invention have been described, it will be understood by those skilled in the art that various modifications in form and details may be made therein without departing from the spirit and scope of the present invention as defined by the following claims. Therefore, it may be understood that the foregoing is illustrative of the present invention and should not to be construed as being limited to the specific embodiments disclosed herein.

What is claimed is:

1. A method for determining a substrate, comprising:
preparing a substrate including a first surface and a second surface having different optical properties;
detecting optical information on one of the first surface or the second surface of the substrate; and
determining whether the one of the first surface or the second surface of the substrate is the first surface or the second surface of the substrate by comparing the optical information and a stored reference value.

2. The method of claim 1, wherein the preparing of the substrate includes fixing the substrate and reading the substrate.

3. The method of claim 1, wherein the detecting of the optical information includes:
emitting light onto the one of the first surface or the second surface of the substrate;
receiving the light reflected from the one of the first surface or the second surface; and
converting the received light into the optical information.

4. The method of claim 1, wherein the determining includes determining the one of the first surface or the second surface as the first surface when the optical information is less than the reference value.

5. The method of claim 1, wherein the substrate includes a first substrate and a second substrate attached on the first substrate,
wherein the first substrate and the second substrate have different optical properties,
wherein the one of the first surface or second surface of the substrate is one surface of the first substrate and the other one of the first surface or second surface of the substrate is one surface of the second substrate.

6. The method of claim 5, wherein the first substrate is a non-flexible substrate and the second substrate is a flexible substrate.

7. A method of forming a flexible display, comprising:
forming a substrate including a first substrate and a second substrate attached on the first substrate;
detecting optical information on one of the first substrate or the second substrate;
determining the one of the first substrate or the second substrate based on the optical information;
comparing the determined one of the first substrate or the second substrate with a process target substrate; and
separating the first substrate and the second substrate.

8. The method of claim 7, wherein the first substrate is a non-flexible substrate and the second substrate is a flexible substrate.

9. The method of claim 7, wherein the forming of the substrate includes:
bonding the first substrate and the second substrate; and
forming a light emitting element layer on the second substrate.

10. The method of claim 7, wherein the detecting of the optical information includes:
emitting light to one of the first substrate or the second substrate;
receiving light reflected from the one of the first substrate or the second substrate; and
converting the received light into the optical information.

11. The method of claim 7, wherein the determining of the first substrate and the second substrate includes:
determining the one of the first substrate or the second substrate by comparing the optical information with a reference value; and
changing a layout of the substrate when the determined one of the first substrate or the second substrate does not coincide with the process target substrate.

12. The method of claim 7, wherein the separating of the first substrate and the second substrate includes irradiating a laser beam on a boundary surface of the first substrate and the second substrate.

13. A method for determining a substrate, comprising:
detecting optical information on one of both surfaces of the substrate; and
determining whether the one of both surfaces of the substrate is a first surface or a second surface of the substrate based on the optical information,
wherein the both surfaces of the substrate have different optical properties,
wherein the optical information is obtained by analyzing light reflected from the one of both surfaces of the substrate.
